(19) United States
(12) Patent Application Publication
(10) Pub. No.: US 2025/0320585 A1
(43) Pub. Date: Oct. 16, 2025

(54) Fe-Mn ALLOY, HAIRSPRING FOR TIMEPIECE, AND METHOD FOR PRODUCING Fe-Mn ALLOY

(71) Applicant: CITIZEN WATCH CO., LTD., Tokyo (JP)

(72) Inventors: Motoaki Kobayashi, Nishitokyo-shi, Tokyo (JP); Mizuki Sasaki, Nishitokyo-shi, Tokyo (JP); Tomoo Ikeda, Nishitokyo-shi, Tokyo (JP)

(73) Assignee: CITIZEN WATCH CO., LTD., Tokyo (JP)

(21) Appl. No.: 18/875,548

(22) PCT Filed: Jun. 8, 2023
(86) PCT No.: PCT/JP2023/021356

§ 371 Date: Dec. 16, 2024

(30) Foreign Application Priority Data
Jun. 17, 2022 (JP) 2022-098326

(51) Int. Cl. C22C 30/00; C22F 1/16; G04B 17/32

(52) U.S. Cl. CPC C22C 30/00; C22F 1/16; G04B 17/32

(57) ABSTRACT

An Fe—Mn alloy includes, by mass, more than 30.0% but not more than 35.0% manganese (Mn), 1.0% to 8.0% aluminum (Al), 0.5% to 1.5% carbon (C), 5.0% to 10.0% chromium (Cr), and 2.5% to 5.0% nickel (Ni) in terms of composition, the remainder being iron (Fe). As a crystal structure, the Fe—Mn alloy has a γ-Fe phase or a β-Mn phase. The sum of the area fractions of the γ-Fe and β-Mn phases being 50% or more.

### FIELD

The present invention relates to an Fe—Mn alloy, a hairspring for a timepiece, and a method for producing an Fe—Mn alloy.

### BACKGROUND

The magnetic environment of precision devices has changed significantly in recent years. Magnets are used in electronic devices, such as smartphones and tablet devices, as well as their chargers, covers, and cases; precision devices are increasingly exposed to higher magnetic fields than in the past. This requires components of precision devices, such as watches, to have properties that make them less sensitive to magnetic fields, in addition to being small, thin, and hard.

Alloys mainly based on elements such as iron and cobalt have been used as material for hairsprings in the balances, or the regulating mechanisms, of mechanical watches and clocks. These alloys are ferromagnetic and thus respond strongly to magnetic fields. On the other hand, there have been proposals to produce hairsprings with non-metallic materials, such as glass and silicon, as materials that do not respond to magnetic fields. However, since glass and silicon are brittle materials, hairsprings produced with these materials have problems with impact resistance.

Patent Literature 1 describes an iron-based antiferromagnetic alloy for use in a component of a timekeeping movement. The antiferromagnetic alloy of Patent Literature 1 has a composition constituted of 10.0% to 30.0% by weight manganese, 4.0% to 10.0% by weight chromium, 5.0% to 15.0% by weight nickel, 0.1% to 2.0% by weight titanium, the remainder being iron and residual impurities. The alloy is free of beryllium.

### CITATION LIST

### Patent Literature

Patent Literature 1: Japanese Unexamined Patent Publication No. 2020-501006

### SUMMARY

An object of the present invention is to provide an Fe—Mn alloy having a low magnetic susceptibility and excellent workability, a hairspring for a timepiece, and a method for producing an Fe—Mn alloy.

An Fe—Mn alloy of an embodiment of the present invention includes, by mass, more than 30.0% but not more than 35.0% manganese (Mn), 1.0% to 8.0% aluminum (Al), 0.5% to 1.5% carbon (C), 5.0% to 10.0% chromium (Cr), and 2.5% to 5.0% nickel (Ni) in terms of composition, the remainder being iron (Fe). As a crystal structure, the Fe—Mn alloy has a γ-Fe phase or a β-Mn phase, and the sum of the area fractions of the γ-Fe and β-Mn phases is 50% or more.

An Fe—Mn alloy of an embodiment of the present invention includes, by mass, 25.0% to 30.0% manganese (Mn), 1.0% to 8.0% aluminum (Al), 0.5% to 1.5% carbon (C), more than 10.0% but not more than 15.0% chromium (Cr), and 2.5% to 5.0% nickel (Ni) in terms of composition, the remainder being iron (Fe). As a crystal structure, the Fe—Mn alloy has a γ-Fe phase or a β-Mn phase, and the sum of the area fractions of the γ-Fe and β-Mn phases is 50% or more.

The magnetic susceptibility of the Fe—Mn alloy is preferably 0.030 or less.

In the Fe—Mn alloy, the sum of the area fractions of the γ-Fe and β-Mn phases is preferably 80% or more.

In the Fe—Mn alloy, the area fraction of the β-Mn phase is preferably greater than the area fraction of the γ-Fe phase.

A hairspring for a timepiece of an embodiment of the present invention is formed of the Fe—Mn alloy of an embodiment of the present invention.

A method for producing an Fe—Mn alloy of an embodiment of the present invention includes a hot working step to obtain a hot-worked product by hot-working an ingot, a cold working step to obtain a cold-worked product by cold-working the hot-worked product, and a hardening heat treatment step to obtain an Fe—Mn alloy by subjecting the cold-worked product to hardening heat treatment. The Fe—Mn alloy includes, by mass, more than 30.0% but not more than 35.0% manganese (Mn), 1.0% to 8.0% aluminum (Al), 0.5% to 1.5% carbon (C), 5.0% to 10.0% chromium (Cr), and 2.5% to 5.0% nickel (Ni) in terms of composition, the remainder being iron (Fe). As a crystal structure, the Fe—Mn alloy has a γ-Fe phase or a β-Mn phase, and the sum of the area fractions of the γ-Fe and β-Mn phases is 50% or more.

A method for producing an Fe—Mn alloy of an embodiment of the present invention includes a hot working step to obtain a hot-worked product by hot-working an ingot, a cold working step to obtain a cold-worked product by cold-working the hot-worked product, and a hardening heat treatment step to obtain an antimagnetic Fe—Mn alloy by subjecting the cold-worked product to hardening heat treatment. The Fe—Mn alloy includes, by mass, 25.0% to 30.0% manganese (Mn), 1.0% to 8.0% aluminum (Al), 0.5% to 1.5% carbon (C), more than 10.0% but not more than 15.0% chromium (Cr), and 2.5% to 5.0% nickel (Ni) in terms of composition, the remainder being iron (Fe). As a crystal structure, the Fe—Mn alloy has a γ-Fe phase or a β-Mn phase, and the sum of the area fractions of the γ-Fe and β-Mn phases is 50% or more.

The present invention provides an Fe—Mn alloy having a low magnetic susceptibility and excellent workability, a hairspring for a timepiece, and a method for producing an Fe—Mn alloy.

### BRIEF DESCRIPTION OF DRAWINGS

FIG. 1 shows the appearance of a hairspring 1;

FIG. 2 is a flowchart of a method for producing the hairspring 1; and

FIG. 3(A) shows a SEM image of an Fe—Mn alloy of a comparative example, and FIG. 3(B) shows a SEM image of an Fe—Mn alloy of an example.

### DESCRIPTION OF EMBODIMENTS

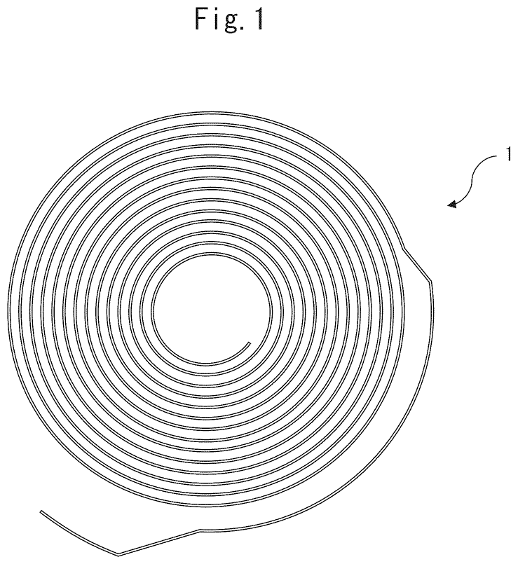

FIG. 1 shows the appearance of a hairspring 1 for a timepiece of an embodiment of the present invention. The hairspring 1 is used in the balance, or the regulating mechanism, of a mechanical watch or clock.

The hairspring 1 is formed by working an Fe—Mn alloy of a first embodiment. The Fe—Mn alloy of the first embodiment includes, by mass, more than 30.0% but not more than 35.0% manganese (Mn), 1.0% to 8.0% aluminum (Al), 0.5% to 1.5% carbon (C), 5.0% to 10.0% chromium (Cr), and 2.5% to 5.0% nickel (Ni) in terms of composition, the remainder being iron (Fe) and inevitable impurities. As a crystal structure, the Fe—Mn alloy has a γ-Fe phase or a β-Mn phase, and the sum of the area fractions of the γ-Fe and β-Mn phases is 50% or more.

The Fe—Mn alloy has an α-phase and a γ-Fe phase or a β-Mn phase as its crystal structure. The α-phase has a cubic crystal structure with a crystal lattice spacing of a=b=c=2.87 Å and two atoms in a unit cell. The γ-Fe phase is also referred to as an austenite phase, and is paramagnetic. The β-Mn phase has a cubic crystal structure with a crystal lattice spacing of a=b=c=6.34 Å and 20 atoms in a unit cell, and is paramagnetic.

The Fe—Mn alloy has a low magnetic susceptibility because of the presence of a γ-Fe or β-Mn phase as its crystal structure.

The following describes the Fe—Mn alloy of the first embodiment in more detail.

The Fe—Mn alloy contains more than 30.0% but not more than 35.0% Mn by mass. With Fe, Mn forms a solid solution whose crystal structure is the γ-Fe phase. The γ-Fe phase undergoes a phase transformation to the β-Mn phase by working and hardening heat treatment. This results in the Fe—Mn alloy having a low magnetic susceptibility and good workability. In other words, too small proportions of the γ-Fe and β-Mn phases cause an increase in the proportion of the α-phase, raising the magnetic susceptibility of the Fe—Mn alloy.

The Fe—Mn alloy contains 1.0% to 8.0% Al by mass. With Fe, Al forms a solid solution whose crystal structure is the α-phase. This results in the Fe—Mn alloy having excellent workability. Too little Al impairs the workability of the Fe—Mn alloy. Al does not affect the magnetic susceptibility of the Fe—Mn alloy because it is paramagnetic.

The Fe—Mn alloy contains 0.5% to 1.5% C by mass. C enters the interior of Fe and stabilizes the crystal structure of the γ-Fe phase. The γ-Fe phase undergoes a phase transformation to the β-Mn phase by working and aging heat treatment. C also improves the workability of the Fe—Mn alloy. Too much C causes M₃C, M₂₃C₆ (M is Fe, Mn, or Cr), and other carbides to precipitate, making the Fe—Mn alloy brittle.

The Fe—Mn alloy contains 5.0% to 10.0% Cr by mass. With Fe, Cr forms a solid solution whose crystal structure is the γ-phase. The γ-Fe phase undergoes a phase transformation to the β-Mn phase by working and aging heat treatment. Cr is present on the boundary between the β-Mn phase and the α-phase, mainly as carbides, and increases the hardness of the Fe—Mn alloy. Cr also forms an oxide layer on the surface of the Fe—Mn alloy, contributing to improved corrosion resistance. In other words, too little Cr results in failure of formation of a sufficient oxide layer and low corrosion resistance. Too much Cr results in the Fe—Mn alloy being excessively hard, which impairs the workability.

The Fe—Mn alloy contains 2.5% to 5.0% Ni by mass. With Fc, Ni forms a solid solution whose crystal structure is the α-phase. Ni also improves the forgeability of the Fe—Mn alloy in hot and/or cold working.

The remainder of the Fe—Mn alloy is Fe. The remainder being Fe means that the composition includes inevitable impurities in addition to Fe. The inevitable impurities are inevitably mixed from raw materials and other sources, or unintentionally and inevitably mixed in the production process. The inevitable impurities are, for example, Si (silicon), P (phosphorus), and S (sulfur). The influence of the inevitable impurities on the properties of the Fe—Mn alloy is minimized by keeping each impurity below 0.1% by mass. The amount of each inevitable impurity is preferably less than 0.01% by mass so that the concentration of the inevitable impurities in some parts of the alloy does not affect the properties of the Fe—Mn alloy.

The Fe—Mn alloy has an α-phase and a γ-Fe phase or a β-Mn phase as its crystal structure. Preferably, at least part of the γ-Fe or β-Mn phase in the Fe—Mn alloy is observed in a SEM image as a continuous phase with an area of 1 μm² or more. In other words, the γ-Fe or β-Mn phase is present in the Fe—Mn alloy as a main crystal structure rather than as fine precipitates. This results in the Fe—Mn alloy having a low magnetic susceptibility and excellent workability.

In the Fe—Mn alloy, the sum of the area fractions of the γ-Fe and β-Mn phases is 50% or more. This results in the Fe—Mn alloy having a low magnetic susceptibility and good workability. The area fractions are determined by measuring the areas of the α-phase, γ-Fe phase, and β-Mn phase in a region of a particular size (e.g., a region 100 μm by 100 μm) in SEM image observation.

Lowering the area fraction of regions in the Fe—Mn alloy other than the α-phase, γ-Fc phase, and β-Mn phase to 10% or less prevents the Fe—Mn alloy from being excessively hard, thus preventing impairment of workability in hot and cold working. Lowering the area fraction of regions in the Fe—Mn alloy other than the α-phase, γ-Fe phase, and β-Mn phase to 1% or less enables inhibiting the appearance of magnetic phases in the Fe—Mn alloy and lowering the magnetic susceptibility further. The regions other than the α-phase, γ-Fe phase, and β-Mn phase are those corresponding to carbides such as Cr carbides. When the area fraction of the regions other than the α-phase, γ-Fe phase, and β-Mn phase are as described above, the influence on the properties of the Fe—Mn alloy is negligible.

The hairspring 1 may be formed by working an Fe—Mn alloy of a second embodiment. The Fe—Mn alloy of the second embodiment includes, by mass, 25.0% to 30.0% manganese (Mn), 1.0% to 8.0% aluminum (Al), 0.5% to 1.5% carbon (C), more than 10.0% but not more than 15.0% chromium (Cr), and 2.5% to 5.0% nickel (Ni) in terms of composition, the remainder being iron (Fe). As a crystal structure, the Fe—Mn alloy has a γ-Fe phase or a β-Mn phase, and the sum of the area fractions of the γ-Fe and β-Mn phases is 50% or more.

The Fe—Mn alloy of the second embodiment differs from the Fe—Mn alloy of the first embodiment in that the former contains less Mn and more Cr. In other words, the Fe—Mn alloy of the second embodiment is such that the Mn content of the Fe—Mn alloy of the first embodiment is reduced and its Cr content is increased instead. With Fe, Cr forms a solid solution whose crystal structure is the γ-phase; in this respect, Cr has properties similar to those of Mn. The Fe—Mn alloy of the second embodiment therefore has a low magnetic susceptibility and excellent workability, similarly to the Fe—Mn alloy of the first embodiment.

### <Method for Producing a Hairspring>

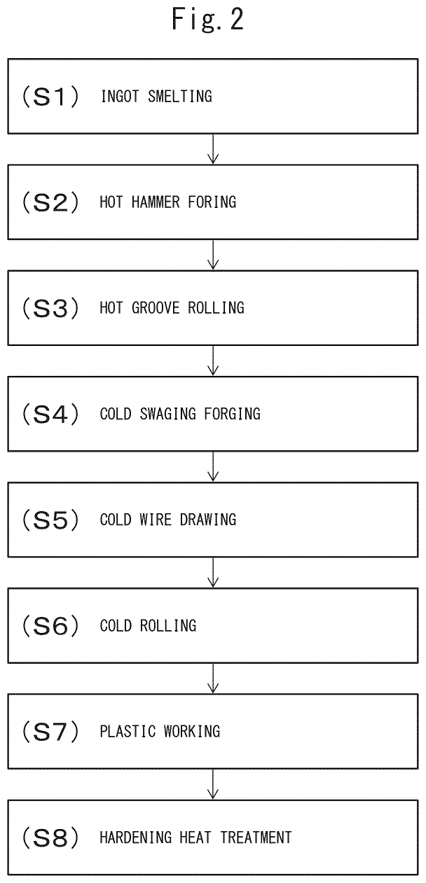

FIG. 2 is a flowchart of a method for producing the hairspring 1. The production method includes an ingot smelting step (step S1), a hot working step (steps S2 and S3), a cold working step (steps S4 to S6), a plastic working step (step S7), and a hardening heat treatment step (step S8). In the ingot smelting step, an ingot is smelted. In the hot working step, the ingot is hot-worked to produce a hot-worked product. In the cold working step, the hot-worked product is cold-worked to produce a cold-rolled material having metal crystals into which dislocation is introduced. The cold-rolled material has a γ-Fe phase and an α-phase as its crystal structure. In the hardening heat treatment step, the cold-rolled material is subjected to hardening heat treatment to produce an Fe—Mn alloy. The introduction of dislocation into the metal crystals in the cold working step leads to a phase transformation from the γ-Fe phase to the β-Mn phase in the hardening heat treatment step.

First, an ingot is smelted (step S1). The ingot is smelted by melting raw materials that have been weighed so as to have a predetermined composition and pouring them into a mold. The raw materials are melted, for example, with high-frequency vacuum melting equipment.

Melting with high-frequency vacuum melting equipment is performed, for example, as follows. To begin with, a ceramic crucible containing the weighed raw materials is loaded into a heating unit of the equipment. The heating unit is equipped with a mechanism that enables pouring described below. A room-temperature mold is also installed in the equipment. The inside of the equipment is evacuated to a vacuum of 1×10⁻² [Pa] or less, and then filled with an inert gas. The inert gas is, for example, nitrogen or argon. In the atmosphere of the inert gas, the raw materials are heated by high-frequency induction. Heating the raw materials for 10 to 45 minutes so that they soften and melt results in the raw materials being in a liquid molten state. Next, the molten metal is kept heated for 5 to 25 minutes so that its temperature is in the range of 1400 to 2000° C. The temperature of the molten metal can be measured by immersing a thermocouple protected by a heat-resistant member in the molten metal. After being kept heated, the molten metal is poured into the room-temperature mold and quenched. After being quenched, the molten metal is left still for 4 to 9 hours, thereby cooling to room temperature and becoming a solid ingot. After being left still, the inside of the equipment is evacuated to a vacuum, and then the equipment is opened to the atmosphere. This enables the ingot to be removed from the mold.

When the Fe—Mn alloy of the first embodiment is produced, the ingot contains, by mass, more than 30.0% but not more than 35.0% Mn, 1.0% to 8.0% Al, 0.5% to 1.5% C, 5.0% to 10.0% Cr, and 2.5% to 5.0% Ni as the predetermined composition, the remainder being Fc.

When the Fe—Mn alloy of the second embodiment is produced, the ingot contains, by mass, 25.0% to 30.0% manganese Mn, 1.0% to 8.0% Al, 0.5% to 1.5% C, more than 10.0% but not more than 15.0% Cr, and 2.5% to 5.0% Ni as the predetermined composition, the remainder being Fc.

In the methods for producing an Fe—Mn alloy of the first and second embodiments, the ingot has a γ-Fc phase and an α-phase as its crystal structure. Preferably, the area fraction of the γ-Fe phase is not less than 50%, and the area fraction of the α-phase is less than 50%. This facilitates a phase transformation to the β-Mn phase in hardening heat treatment.

Next, the ingot is hot-worked to obtain a hot-worked product. As hot working, hot hammer forging (step S2) and then hot groove rolling (S3) are performed. This yields a bar as the hot-worked product. Hot working is performed between 1100° C. and 1250° C. inclusive. The resulting hot-worked product is water-cooled.

The composition and the area fraction of the crystal structure of the hot-worked product are similar to those of the ingot. Preferably, the size of metal grains in the hot-worked product is 10 μm or less. This results in the Fe—Mn alloy, which is the final product, having a high hardness. Preferably, a working rate in hot working is from 45% to 80%. The working rate refers to the rate of reduction in cross-sectional area. In other words, the working rate is one minus the ratio of the cross-sectional area of the bar, the material after working, to the cross-sectional area of the ingot, the material before working. A working rate in hot working of 45% to 80% results in the size of metal grains being 10 μm or less.

Next, the water-cooled hot-worked product is cold-worked to produce a cold-rolled material, which is a cold-worked product. As cold working are performed cold swaging forging (step S4), cold wire drawing (step S5), and cold rolling (step S6).

Cold swaging forging (step S4) is the step of cold-forging the bar, which is the hot-worked product, to obtain a thin bar with a smaller outer diameter. Cold wire drawing (step S5) is the step of subjecting the thin bar to a drawing process with a diamond die to obtain a drawn wire rod. Cold rolling (step S6) is the step of rolling the drawn wire rod so that the cross section of the drawn wire rod changes from a circle to a rectangle, thereby obtaining a cold-rolled material. This yields a belt-shaped ribbon material as the cold-rolled material.

Dislocation is introduced into the metal crystals of the thin bar obtained by cold swaging forging (step S4), the drawn wire rod obtained by cold wire drawing (step S5), and the ribbon material obtained by cold rolling (step S6). Preferably, the working rate in cold working is from 20% to 90%, more preferably from 40% to 80%. This introduces a suitable amount of dislocation into the metal crystals and facilitates a phase transformation of the crystal structure from the γ-Fe phase to the β-Mn phase, enabling the hairspring 1, which is the final product, to have a desired hardness. Since the β-Mn phase is harder than the γ-Fe phase, in the Fe—Mn alloy the area fraction of the β-Mn phase is preferably greater than the area fraction of the γ-Fe phase. This enables the hairspring 1, which is the final product, to have a desired hardness.

The composition and the area fraction of the crystal structure of the cold-rolled material are similar to those of the ingot. Preferably, the size of metal grains in the cold-rolled material is 10 μm or less. This enables the hairspring 1, which is the final product, to have a desired hardness.

Next, in the plastic working step (step S7), the ribbon material, or the cold-rolled material, is cut to a predetermined length, and then held in a spiral shape with a jig or similar tool, thereby being formed into the shape of the hairspring 1.

Finally, in the hardening heat treatment step (step S8), hardening heat treatment is applied to the formed cold-rolled material to obtain the hairspring 1. The hardening heat treatment leads to a phase transformation from the γ-Fe phase to the β-Mn phase.

The hardening heat treatment is performed between 550° C. and 800° C. inclusive, preferably between 600° C. and 700° C. inclusive. This enables the hairspring 1, which is the final product, to have a desired hardness. Too high temperature in the hardening heat treatment may lower the hardness of the hairspring 1. The hardening heat treatment is performed for 10 minutes to 12 hours. This results in the area fraction of the β-Mn phase of the Fe—Mn alloy being 50% or more, enabling the hairspring 1 to have a low magnetic susceptibility and a desired hardness. Too much time in the hardening heat treatment may lower the hardness of the hairspring 1. The hairspring 1 obtained by the hardening heat treatment is air-cooled.

The composition and the area fraction of the crystal structure of the hairspring 1 obtained by the hardening heat treatment are similar to those of the ingot. The hairspring 1 has an α-phase and a β-Mn phase as its crystal structure, and the area fraction of the β-Mn phase is 50% or more. The hairspring 1 has a lower magnetic susceptibility because of the presence of the β-Mn phase whose area fraction is 50% or more.

In the method for producing the hairspring 1, a homogenizing heat treatment step may be performed to heat-treat and homogenize the ingot, before the hot working step. The homogenizing heat treatment is performed, for example, between 1000° C. and 1200° C. inclusive for 0.5 to 3 hours. This makes metal crystals uniform in the ingot.

In the method for producing the hairspring 1, an annealing step may be performed to anneal the hot-worked product obtained in the hot working step, between the hot working step and the cold working step. Annealing is performed, for example, between 1000° C. and 1200° C. inclusive for 0.5 to 3 hours. This makes metal crystals uniform in the hot-worked product.

The method for producing the hairspring 1 is not limited to the above example. The hairspring 1 may be produced by a method different from that described above.

It should be understood that those skilled in the art can make various changes, substitutions, and modifications without departing from the spirit and scope of the present invention.

### Example 1

The following describes the above embodiments in more detail, based on examples, but the present invention is not limited to these examples.

### Example 1

Materials were weighed at a composition ratio of 35.0% Mn, 8.0% Al, 1.5% C, 10.0% Cr, and 5.0% Ni by mass, the remainder being Fe. The steps of the above production method except the plastic working step (step S7) were performed with these materials to produce a ribbon material of an Fe—Mn alloy. In the production method, the working rate in hot working was 70% while the working rate in cold working was 80%. The hardening heat treatment was performed at 600° C. for 12 hours.

### Example 2

Materials were weighed at a composition ratio of 31.0% Mn, 5.0% Al, 0.5% C, 5.0% Cr, and 2.5% Ni by mass, the remainder being Fe. These materials were used to produce a ribbon material of an Fe—Mn alloy by a production method similar to that in Example 1.

### Example 3

Materials were weighed at a composition ratio of 30.0% Mn, 5.0% Al, 1.0% C, 15.0% Cr, and 5.0% Ni by mass, the remainder being Fe. These materials were used to produce a ribbon material of an Fe—Mn alloy by a production method similar to that in Example 1.

### Example 4

Materials were weighed at a composition ratio of 31.0% Mn, 3.0% Al, 0.5% C, 5.0% Cr, and 2.5% Ni by mass, the remainder being Fe. These materials were used to produce a ribbon material of an Fe—Mn alloy by a production method similar to that in Example 1.

### Example 5

Materials were weighed at a composition ratio of 31.0% Mn, 2.0% Al, 0.5% C, 5.0% Cr, and 2.5% Ni by mass, the remainder being Fe. These materials were used to produce a ribbon material of an Fe—Mn alloy by a production method similar to that in Example 1.

### Example 6

Materials were weighed at a composition ratio of 31.0% Mn, 1.0% Al, 0.5% C, 5.0% Cr, and 2.5% Ni by mass, the remainder being Fe. These materials were used to produce a ribbon material of an Fe—Mn alloy by a production method similar to that in Example 1.

### Comparative Example 1

Materials were weighed at a composition ratio of 30.0% Mn, 8.0% Al, 1.0% C, 10.0% Cr, and 5.0% Ni by mass, the remainder being Fe. These materials were used to produce a ribbon material of an Fe—Mn alloy by a production method similar to that in Example 1.

### Comparative Example 2

Materials were weighed at a composition ratio of 31.0% Mn and 5.0% Al by mass, the remainder being Fe. These materials were used to produce a ribbon material of an Fe—Mn alloy by a production method similar to that in Example 1.

### Comparative Example 3

Materials were weighed at a composition ratio of 31.0% Mn, 0.5% C, 5.0% Cr, and 2.5% Ni by mass, the remainder being Fe. These materials were used to produce a ribbon material of an Fe—Mn alloy by a production method similar to that in Example 1.

### <Measurement of Area Fractions>

The final ribbon materials obtained in Examples 1 to 6 and Comparative examples 1 and 3 were observed using a reflection electron microscope. Specifically, the ribbon materials were cut in the radial direction; the cut surfaces were polished with a buffing pad, using a rotary polisher; and the resulting smooth surfaces were observed.

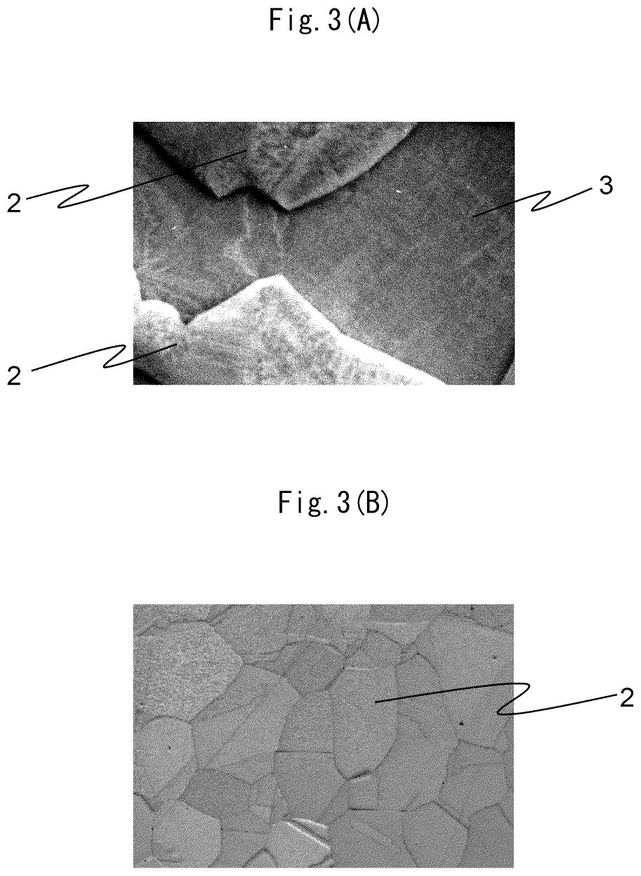

FIG. 3(A) is a SEM image of Comparative example 1 before heat treatment, observed at a magnification of 5000 times. FIG. 3(B) is a SEM image of Example 2 before heat treatment, observed at a magnification of 200 times. In the SEM images, grey areas 2 are a γ-Fe phase, and black areas 3 are an α-phase. The areas of the SEM images and those of the γ-Fe phases were measured. The area fraction refers to the ratio of the area of a particular phase to the area observed in a SEM image. In other words, the area fraction of a γ-Fe phase is the ratio of the area of the γ-Fe phase to the area observed in a SEM image.

FIGS. 3(A) and 3(B) show images before heat treatment; however, since hardening heat treatment causes a phase transformation to the β-Mn phase in at least part of the γ-Fe phase, the γ-Fe and β-Mn phases are observed in SEM images of the cross sections of the ribbon materials after heat treatment. In each ribbon material after heat treatment, the sum of the area fractions of the γ-Fe and β-Mn phases is calculated as the area fraction, as described above. The area fraction of the γ-Fe phase before heat treatment is approximately equal to the sum of the area fractions of the γ-Fe and β-Mn phases after heat treatment.

### <Evaluation of Magnetic Properties>

The magnetic susceptibilities of the final ribbon materials obtained in Examples 1 to 6 and Comparative examples 1 and 3 were measured. The measurement was performed on 3-mm thick test pieces cut from the ribbon materials. Specifically, the magnetic field whose maximum was −398 [kA/m] to +398 [kA/m] (−4900 [G] to +4900 [G]) was applied to each test piece, and the magnetic susceptibility was calculated based on the magnetization curve (M-H curve) obtained by measuring the magnetization of the test piece.

### <Evaluation of Workability>

The steps of the above production method, including the plastic working step (step S7), were performed with materials weighed at the composition ratios shown in Examples 1 to 6 and Comparative examples 1 to 3. If it was possible to form a ribbon material obtained in the process up to step S6 into the shape of a hairspring in step S7, the workability was evaluated as sufficient; if forming was impossible, the workability was evaluated as insufficient. Cases where forming was impossible include a case where the material was too hard to be formed and a case where the material was damaged during the forming process because of brittleness.

Table 1 shows the composition ratios of Examples 1 to 6 and Comparative examples 1 to 3 as well as the area fractions of the γ-Fe phase, the magnetic susceptibilities, and the results of the workability evaluation of the final ribbon materials. The results of the workability evaluation are shown as “Y” if the workability is sufficient and “N” if it is insufficient.

TABLE 1

| | | | | | | Area | Magnetic | |
|---|---|---|---|---|---|---|---|---|
| | Composition ratio [%] | | | | | fraction | suscepti- | Work- |
| | Mn | Al | C | Cr | Ni | [%] | bility | ability |
| Example 1 | 35.0 | 8.0 | 1.5 | 10.0 | 5.0 | 74 | 0.024 | Y |
| Example 2 | 31.0 | 5.0 | 0.5 | 5.0 | 2.5 | 99< | 0.003 | Y |
| Example 3 | 30.0 | 5.0 | 1.0 | 15.0 | 5.0 | 80 | 0.002 | Y |
| Example 4 | 31.0 | 3.0 | 0.5 | 5.0 | 2.5 | 99< | 0.003 | Y |
| Example 5 | 31.0 | 2.0 | 0.5 | 5.0 | 2.5 | 99< | 0.002 | Y |
| Example 6 | 31.0 | 1.0 | 0.5 | 5.0 | 2.5 | 99< | 0.005 | Y |
| Comparative | 30.0 | 8.0 | 1.0 | 10.0 | 5.0 | 45 | 0.2 | Y |
| example 1 | | | | | | | | |
| Comparative | 31.0 | 5.0 | 0 | 0 | 0 | — | — | N |
| example 2 | | | | | | | | |
| Comparative | 31.0 | 0 | 0.5 | 5.0 | 2.5 | 99< | 0.001 | N |
| example 3 | | | | | | | | |

The area fractions of the γ-Fe phase of the ribbon materials of Examples 1 and 3 and Comparative example 1 were 74%, 80%, and 45%, respectively. The area fractions of the γ-Fe phase of the ribbon materials of Examples 2 and 4 to 6 and Comparative example 3 were all greater than 99%.

The magnetic susceptibilities of the ribbon materials of Examples 1 to 6 were 0.024, 0.003, 0.002, 0.003, 0.002, and 0.005, respectively, all of which were small values below 0.03 and suitable for use as hairsprings. Thus, hairsprings formed from these ribbon materials would also have a suitable magnetic susceptibility. In contrast, the magnetic susceptibility of the ribbon material of Comparative example 1 was 0.2, which was insufficient for use as a hairspring. This may be because precipitation of a magnetic fine carbide M₂₃C₆ (M is Fe, Mn, or Cr) was promoted by the hardening heat treatment in the ribbon material of Comparative example 1 and contributed to an increase in magnetic susceptibility. Thus, a hairspring formed from this ribbon material would not have a suitable magnetic susceptibility.

The ribbon material of Comparative example 2 was evaluated as having an insufficient working rate because it broke during the process of cold working because of brittleness; its area fraction and magnetic susceptibility were not measured. The ribbon material of Comparative example 3 was evaluated as having an insufficient working rate because it broke during the process of plastic working; its area fraction was not measured. Thus the ribbon materials of Comparative examples 2 and 3 would be unsuitable for use as a hairspring.

1. An Fe—Mn alloy comprising, by mass,
more than 30.0% but not more than 35.0% manganese (Mn),
1.0% to 8.0% aluminum (Al),
0.5% to 1.5% carbon (C),
5.0% to 10.0% chromium (Cr), and
2.5% to 5.0% nickel (Ni) in terms of composition,
the remainder being iron (Fe),
as a crystal structure, the Fe—Mn alloy having a γ-Fe phase or a β-Mn phase, and the sum of the area fractions of the γ-Fe and β-Mn phases being 50% or more.

2. (canceled)

3. The Fe—Mn alloy according to claim 1, wherein
the magnetic susceptibility is 0.030 or less.

4. The Fe—Mn alloy according to claim 1, wherein
the sum of the area fractions of the γ-Fe and β-Mn phases is 80% or more.

5. The Fe—Mn alloy according to claim 1, wherein
the area fraction of the β-Mn phase is greater than the area fraction of the γ-Fe phase.

6. A hairspring for a timepiece, the hairspring being formed of the Fe—Mn alloy according to claim 1.

7. A method for producing an Fe—Mn alloy, the method comprising:
a hot working step to obtain a hot-worked product by hot-working an ingot,
a cold working step to obtain a cold-worked product by cold-working the hot-worked product, and
a hardening heat treatment step to obtain an Fe—Mn alloy by subjecting the cold-worked product to hardening heat treatment,
the Fe—Mn alloy comprising, by mass,
more than 30.0% but not more than 35.0% manganese (Mn),
1.0% to 8.0% aluminum (Al),
0.5% to 1.5% carbon (C),
5.0% to 10.0% chromium (Cr), and
2.5% to 5.0% nickel (Ni) in terms of composition,
the remainder being iron (Fe),
as a crystal structure, the Fe—Mn alloy having a γ-Fe phase or a β-Mn phase, and the sum of the area fractions of the γ-Fe and β-Mn phases being 50% or more.

8. (canceled)
